(19) United States
(12) Patent Application Publication
(10) Pub. No.: US 2018/0203623 A1
(43) Pub. Date: Jul. 19, 2018

(54) INFORMATION PROCESSING APPARATUS, METHOD OF CONTROLLING THE SAME AND STORAGE MEDIUM

(71) Applicant: CANON KABUSHIKI KAISHA, Tokyo (JP)

(72) Inventor: Takeru Imamura, Nagareyama-shi (JP)

(21) Appl. No.: 15/868,244

(22) Filed: Jan. 11, 2018

(30) Foreign Application Priority Data
Jan. 19, 2017 (JP) 2017-007883

(51) Int. Cl. G06F 3/06

(52) U.S. Cl. CPC G06F 3/0619; G06F 3/0653; G06F 3/065; G06F 3/0679

(57) ABSTRACT

It is disclosed that an information processing apparatus has a first storage device mounted on a substrate of the apparatus, a connector provided on the substrate to which a storage device for adding on is connected, a change unit configured to change a storage device to use from the first storage device to a second storage device connected to the connector in a case where a total amount of data written to the first storage device exceeds a first threshold value, and a copy unit configured to, in a case where a total amount of data written to the second storage device exceeds a second threshold value, copy data stored in the second storage device to the first storage device for an exchange of the second storage device wherein the first threshold value is set to a value lower than the second threshold value.

### BACKGROUND OF THE INVENTION

### Field of the Invention

The present invention relates to an information processing apparatus, a method of controlling the same, and a storage medium.

### Description of the Related Art

Image forming apparatuses such as a printer or an MFP widely use a hard disk drive (HDD) as storage (a storage device) for storing data such as image data or setting data. At present, to realize high performance for an image forming apparatus, it is being examined to install a solid state drive (SSD) which has high access speed as storage in an image forming apparatus.

Typically, an SSD configured by NAND flash memory has restrictions on a rewrite count of a cell that records data. Therefore, in a case of using an SSD, there is a necessity to cause an information processing apparatus such as an image forming apparatus in which an SSD is installed to operate in consideration of a lifetime associated with writing of data. Japanese Patent Laid-Open No. 2010-538372 recites that, in an apparatus provided with a plurality of connectors to which respective memory modules are connected, in order to exchange a memory module when the memory module is near the end of its lifetime, data is backed up to a memory module connected to a different connector.

As a configuration for reducing a number of parts needed more than in a case of making it possible to exchange a plurality of storages as described above, there is a configuration in which one storage is mounted in advance on a substrate of an information processing apparatus and it is possible to add on storage as necessary. In such a configuration, when the end of the lifetime of the storage mounted on the substrate is near, control for adding on a new storage and switching the storage used to the added storage can be performed.

In a case of realizing the control described above, downtime for the information processing apparatus occurs when the information processing apparatus cannot operate in conjunction with adding on a storage. Therefore, there is a need to realize adding on storage while preventing the occurrence of downtime as much as possible. In addition, in the control described above, even in a case where the end of the lifetime of a storage for adding on is near and exchange of the storage has become necessary, the information processing apparatus may cease to be able to operate until exchange of the storage completes.

### SUMMARY OF THE INVENTION

The present invention was conceived in view of the above described issues. The present invention provides a technique for, in an information processing apparatus capable of adding on a storage, enabling exchange or adding on of a storage while continuing operation of the information processing apparatus when a storage in use is near the end of its lifetime.

According to one aspect of the present invention, there is provided an information processing apparatus comprising: a first storage device mounted on a substrate of the information processing apparatus; a connector provided on the substrate to which a storage device for adding on is connected; a change unit configured to change a storage device to use from the first storage device to a second storage device connected to the connector in a case where a total amount of data written to the first storage device exceeds a first threshold value; and a copy unit configured to, in a case where a total amount of data written to the second storage device exceeds a second threshold value, copy data stored in the second storage device to the first storage device for an exchange of the second storage device, wherein the first threshold value is set to a value lower than the second threshold value.

According to another aspect of the present invention, there is provided an information processing apparatus comprising: a first storage device mounted on a substrate of the information processing apparatus; a connector provided on the substrate to which a storage device for adding on is connected; a change unit configured to change a storage device to use from the first storage device to a second storage device connected to the connector in a case where a number of times data is written to the first storage device exceeds a first threshold value; and a copy unit configured to, in a case where a number of times data is written to the second storage device exceeds a second threshold value, copy data stored in the second storage device to the first storage device for an exchange of the second storage device, wherein the first threshold value is set to a value lower than the second threshold value.

According to still another aspect of the present invention, there is provided a method of controlling an information processing apparatus provided with a first storage device mounted on a substrate and a connector provided on the substrate to which a storage device for adding on is connected, the method comprising: changing a storage device to use from the first storage device to a second storage device connected to the connector in a case where a total amount of data written to the first storage device exceeds a first threshold value; and in a case where a total amount of data written to the second storage device exceeds a second threshold value, copying data stored in the second storage device to the first storage device for an exchange of the second storage device, wherein the first threshold value is set to a value lower than the second threshold value.

According to yet another aspect of the present invention, there is provided a non-transitory computer-readable storage medium storing a computer program for causing a computer to execute a method of controlling an information processing apparatus provided with a first storage device mounted on a substrate and a connector provided on the substrate to which a storage device for adding on is connected, the method comprising: changing a storage device to use from the first storage device to a second storage device connected to the connector in a case where a total amount of data written to the first storage device exceeds a first threshold value; and in a case where a total amount of data written to the second storage device exceeds a second threshold value, copying data stored in the second storage device to the first storage device for an exchange of the second storage device, wherein the first threshold value is set to a value lower than the second threshold value.

By the present invention, it is possible to, in an information processing apparatus that enables adding on of a storage, perform exchange or adding on of a storage while continuing operation of the information processing apparatus when a storage in use is near the end of its lifetime. In addition, when the end of the lifetime of an added-on storage is near, it is possible to automatically copy data to a storage mounted on a substrate without requiring exchange of the substrate itself.

Further features of the present invention will become apparent from the following description of exemplary embodiments (with reference to the attached drawings).

### BRIEF DESCRIPTION OF THE DRAWINGS

FIG. 1 is a block diagram illustrating an example hardware configuration of an MFP.

FIG. 2A through FIG. 2C schematically illustrate an example of mounting an SSD with respect to a substrate of a controller.

FIG. 3 schematically illustrates an example of a connection of an SSD with respect to a substrate of a controller.

FIG. 4 is a flowchart illustrating a procedure for switching a storage that is used in the MFP.

FIG. 5 illustrates an example of setting threshold values Dth1 and Dth2 used in a determination relating to the lifetime of SSD-A and SSD-B.

FIG. 6A is a state transition diagram illustrating an example transition of operation states of storages installed in the MFP.

FIG. 6B illustrates an example of controlling an SSD-A and an SSD-B in each operation state.

FIG. 7 is a flowchart illustrating a procedure for switching a storage that is used in the MFP.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

In the following embodiment, explanation is given for a multi-function peripheral (MFP) that is an image forming apparatus (image processing apparatus) having a plurality of functions such as a print function, a copy function, an image transmission function, and an image saving function, as an example of an information processing apparatus. Note that the present embodiment can be applied similarly to not only an MFP but also information processing apparatuses such as a printing apparatus (a printer), a copying machine, a facsimile apparatus, and a PC.

<Configuration of MFP>

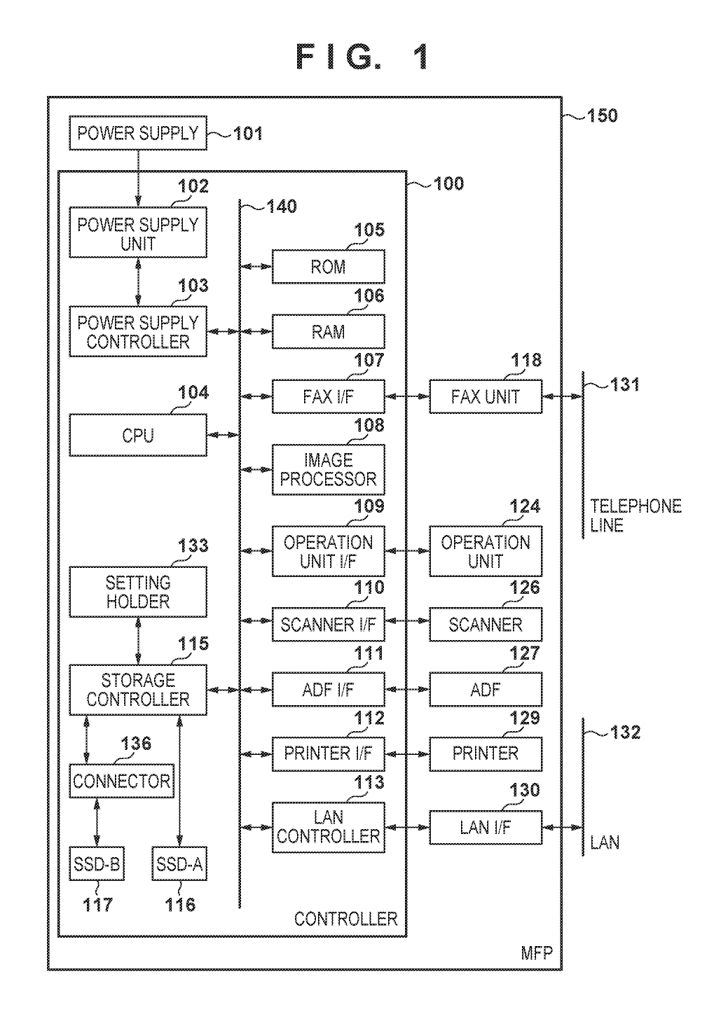

FIG. 1 is a block diagram illustrating an example of a hardware configuration of an MFP 150. The MFP 150 is provided with a controller 100 as well as a power supply 101, a FAX unit 118, an operation unit 124, a scanner 126, an ADF 127, a printer 129, and a LAN interface (I/F) 130 which are connected to the controller 100. The controller 100 is provided with a power supply controller 103, a CPU 104, a ROM 105, a RAM 106, a FAX I/F 107, an image processor 108, an operation unit I/F 109, a scanner I/F 110, an ADF I/F 111, a printer I/F 112, a LAN controller 113, and a storage controller 115. Each of these devices is connected to a serial bus 140 in the controller 100. The controller 100 is also provided with a power supply unit 102 connected to the power supply controller 103, a setting holder 133 connected to the storage controller 115, and a connector 136.

The CPU 104 controls the MFP 150 as a whole by reading a program stored in the ROM 105 or a storage (SSDs 116 and 117) that can be accessed via the storage controller 115 into the RAM 106, and executing the program. The ROM 105 stores a boot program for the MFP 150, a control program, and data such as various setting values. The RAM 106 is used, for example, to temporarily store data used by the CPU 104, or a program executed by the CPU 104.

The operation unit 124 is provided with a hard key and a liquid crystal display unit having a touch panel function, and accepts an instruction inputted by a user. The operation unit I/F 109 is an interface for connecting the controller 100 and the operation unit 124. The LAN controller 113 is connected to a LAN 132 via the LAN I/F 130, and controls communication with an external apparatus that is connected via the LAN 132. The FAX unit 118 is connected to a telephone line 131, and performs FAX communication with an external apparatus via the telephone line 131. The FAX I/F 107 controls FAX communication performed by the FAX unit 118.

The ADF (Auto Document Feeder) 127 conveys originals one at a time to the scanner 126. The scanner 126 generates image data by reading an image of an original placed on an original platen or an image of an original conveyed by the ADF 127. The CPU 104 controls the ADF 127 via the ADF I/F 111, and controls the scanner 126 via the scanner I/F 110. The printer 129 forms (prints) an image on a recording material (sheet) based on inputted image data. The printer 129 is inputted with image data that is received via the LAN 132 and has undergone image processing by the image processor 108, or image data generated by the scanner 126, for example. The CPU 104 controls the printer 129 via the printer I/F 112.

The power supply unit 102 in the controller 100 is connected to the power supply 101 of the MFP 150. The power supply unit 102 generates, from power supplied from the power supply 101, power to be supplied to each device in the MFP 150. The power supply controller 103 controls supply and stoppage of power to each device from the power supply unit 102. For example, the power supply controller 103 can control supply of power to each device from the power supply unit 102 so that the MFP 150 transitions to a power saving mode.

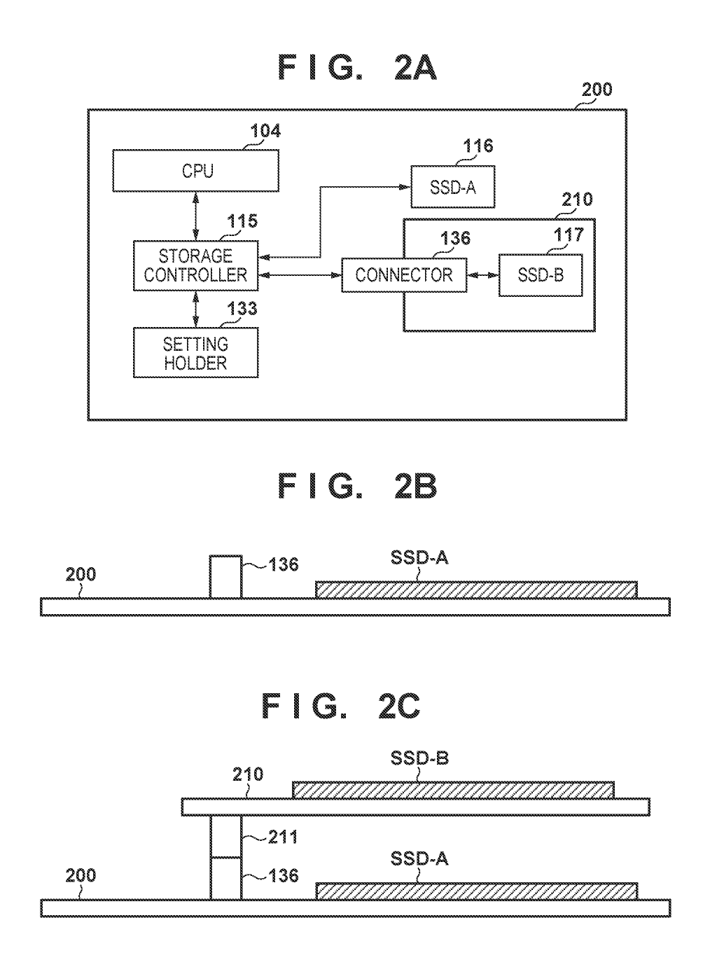

The controller 100 is provided with an SSD 116 (hereinafter may be referred to as “SSD-A”) as a standard storage. The SSD-A (a first storage device) is an onboard SSD arranged (mounted) on a substrate of the controller 100 (a substrate 200 of FIG. 2A through FIG. 2C). The SSD-A is connected to the storage controller 115. The controller 100 is provided with an SSD 117 (hereinafter may be referred to as “SSD-B”) as an add-on storage. The connector 136 is a connector that is provided in the substrate 200 and that is used to add on the SSD-B to the MFP 150 (the controller 100). The SSD-B is added on to the controller 100 by being connected to the connector 136. The SSD-A and the SSD-B are non-volatile storage devices. Thus, the MFP 150 is an example of an information processing apparatus that enables adding on of a storage.

The storage controller 115 is connected to the CPU 104 by serial ATA (SATA), and controls the SSD-A and the SSD-B in accordance with an instruction or command from the CPU 104. Note that parallel ATA (PATA) may be used instead of SATA. In addition, a configuration in which the storage controller 115 is not provided and the SSD-A and the CPU 104 are directly connected may be employed.

In accordance with a command from the CPU 104, the storage controller 115 performs reading or writing of data with respect to the SSD-A and the SSD-B. The storage controller 115 has a function for performing a mirroring operation (a mirror operation) between the SSD-A and the SSD-B. Mirroring is a technique for, by writing the same data to two storages, enabling operation of an apparatus to continue by using one storage even if the other storage has malfunctioned.

The setting holder 133 holds setting data (setting values) used by the storage controller 115. A flash ROM, an SRAM in which data is held by using a button-type battery, or the like is used for the setting holder 133. The setting data stored in the setting holder 133 includes information of the SSD-A and the SSD-B (serial numbers or the like), and information such as an operation state (operation mode) of the storage controller 115.

<Example of Mounting SSD-A and SSD-B>

FIG. 2A through FIG. 2C schematically illustrate an example of mounting the SSD-A and the SSD-B with respect to the substrate 200 of the controller 100. As illustrated in FIG. 2A, the CPU 104, the storage controller 115, and the setting holder 133 are mounted on the substrate 200, and the SSD-A is also mounted on the substrate 200. The CPU 104 can access the SSD-A via the storage controller 115.

In a case where the SSD-B is not installed in the MFP 150 in advance, it is possible to subsequently add on the SSD-B to the MFP 150. SSD-B is added on to the MFP 150 (the controller 100) by being connected to the connector 136. In a case where the SSD-B has been added on, the CPU 104 can access the SSD-B via the storage controller 115.

FIG. 2B illustrates a state in which the SSD-A is mounted on the substrate 200, and FIG. 2C illustrates a state in which the SSD-B has been added. As illustrated in FIG. 2C, the SSD-B is mounted on a child substrate 210. A connector 211 is provided on the child substrate 210. The child substrate 210 is connected to the substrate 200 by the connector 211 being connected to the connector 136 provided on the substrate 200. By this, the SSD-B is added on to the MFP 150 (the controller 100).

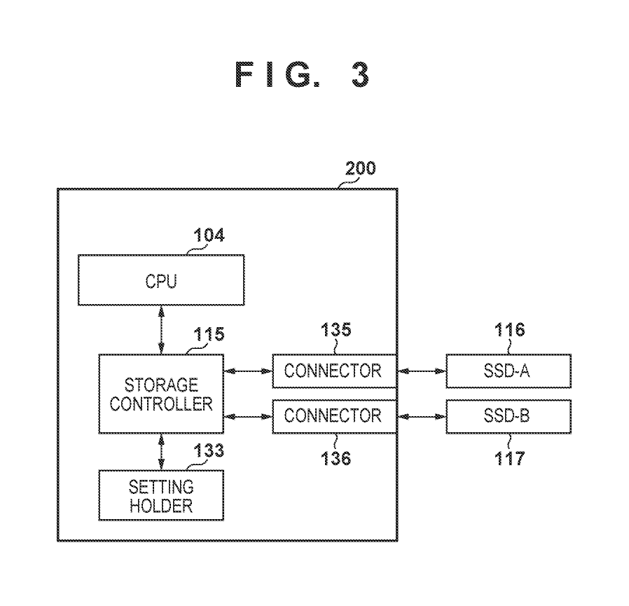

Note that, instead of a configuration in which the SSD-A and the SSD-B are respectively mounted on the substrate 200 and the child substrate 210, it is also possible to employ a configuration in which the SSD-A and the SSD-B respectively connect to connectors 135 and 136 provided on the substrate 200 as illustrated in FIG. 3. In the configuration of FIG. 3, the SSD-A and the SSD-B are respectively connected to the connectors 135 and 136 via cables. Note that it is possible to have a number of parts required in the configuration illustrated in FIG. 2A through FIG. 2C be less than those in the configuration illustrated in FIG. 3.

As first and second embodiments, explanation is given below regarding processing for, if the end of the lifetime of the SSD-A installed in the MFP 150 is near, enabling operation of the MFP 150 to continue by switching the storage (SSD) to use to the SSD-B which was added on. In the first and second embodiments, the SSD-A is installed beforehand in a state of having been mounted on the substrate 200 of the controller 100. The SSD-B is added on as necessary, on the basis of the lifetime of the SSD-A.

Specifically, the CPU 104 uses the SSD-A which is the standard storage until the end of the lifetime of the SSD-A is near. Upon detecting that the end of the lifetime of the SSD-A is near, the CPU 104 prompts a user to add on the SSD-B. After the SSD-B is added on, the storage controller 115, in accordance with an instruction from the CPU 104, copies (backs up) data from the SSD-A to the SSD-B, and switches (changes) the storage to use from the SSD-A to the SSD-B. Note that, in conjunction with switching of the storage to use, the CPU 104 changes a setting of the storage controller 115. The change of the setting of the storage controller 115 is performed by changing setting data held in the setting holder 133.

### First Embodiment

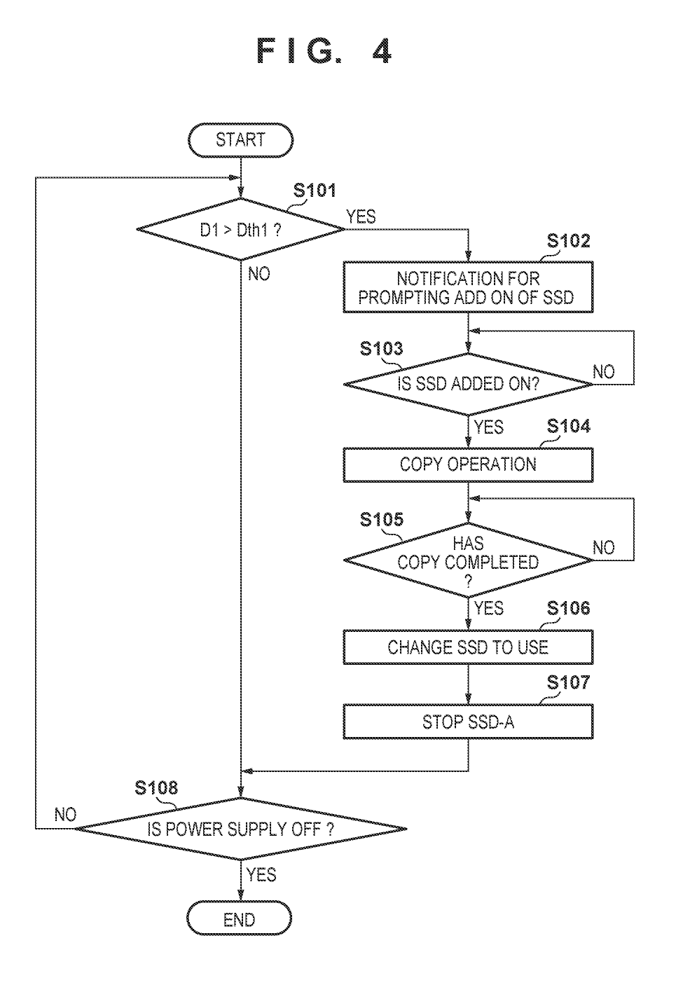

In the first embodiment, a more detailed explanation is given regarding the processing described above. FIG. 4 is a flowchart illustrating a procedure for switching the storage to use in the MFP 150, according to the first embodiment. The processing of each step illustrated in FIG. 4 is realized in the MFP 150 by processing in which the CPU 104 reads out a control program stored in the ROM 105 or the like and executes the control program. Note that the processing of each step may be realized by hardware such as an FPGA or an ASIC.

When the power supply 101 of the MFP 150 is activated from an off state to an on state, the CPU 104 starts execution of processing in accordance with the procedure of FIG. 4. Note that this processing is executed in a case where adding on of the SSD-B and changing of the storage to use (changing from the SSD-A to the SSD-B) has not yet been performed. In addition, processing according to the procedure of FIG. 4 can be executed in parallel with a normal operation by the MFP 150 (an operation such as copying, scanning, and printing) while the power supply 101 is in the on state.

In step S101, the CPU 104 determines whether or not a total data amount D1 that has been written to the SSD-A exceeds a predetermined threshold value Dth1 (D1>Dth1), and advances the processing to step S102 if the total data amount D1 exceeds the threshold value Dth1, and advances the processing to step S108 if the total data amount D1 does not exceed the threshold value Dth1. In this determination, a determination on whether or not it is necessary to add on the SSD-B is made by quantitatively determining, based on the total data amount D1, whether or not the end of the lifetime of the SSD-A is near. Here, the lifetime of an SSD (the SSD-A and the SSD-B) can be indicated in accordance with a total data amount Dm that can be written until the end of the lifetime of the SSD is reached. Therefore, based on the total data amount D1 written thus far to an SSD in use, it is possible to determine whether or not the end of the lifetime of the SSD is near.

The CPU 104 can obtain the total data amount D1 from SMART (Self Monitoring Analysis and Reporting Technology) information of the SSD-A. The SMART information is stored in the SSD-A, and includes information such as a total amount of data written to the SSD-A thus far, an error rate, and an energized period, for example. Note that the total data amount D1 can also be obtained by accumulating an amount of data written, each time writing of data to the SSD-A is performed.

In addition, the threshold value Dth1 can be predetermined as a total data amount for which it is determined that adding on of the SSD-B is necessary. It is necessary for the threshold value Dth1 to be defined to be a value smaller than the total data amount Dm which corresponds to the actual lifetime, so that the end of the lifetime of the SSD-A is not reached before adding on of the SSD-B completes. In the present embodiment, as an example, the threshold value Dth1 is defined to a value that is 99% of the total data amount (in other words, the total writeable data amount) Dm corresponding to the lifetime of the SSD-A (Dth1=0.99*Dm). In this way, it is possible to define the threshold value Dth1 as a ratio with respect to the total data amount Dm which corresponds to the lifetime of the SSD-A. Note that the threshold value Dth1 may be defined as a smaller value in consideration of a frequency at which the CPU 104 obtains the SMART information from the SSD-A.

In step S102, the CPU 104 notifies a user (including an administrator or a service person) that adding on of an SSD (the SSD-B) to the MFP 150 is necessary. The CPU 104 may display, on the operation unit 124, a message prompting a user to add on the SSD-B, and may notify such a message to a user via the LAN 132. Subsequently, in step S103, the CPU 104 determines whether or not the SSD-B has been added on to the MFP 150 by detecting a connection of the SSD-B to the connector 136. The CPU 104 repeats the determination of step S103 if the SSD-B has not been added on, and advances the processing to step S104 if the SSD-B has been added on.

Note that a detection circuit that is for detecting a connection of the SSD-B and that is connected to the power supply controller 103 may be provided between the power supply unit 102 and the SSD-B. By the power supply controller 103 communicating a detection result obtained by using the detection circuit to the CPU 104, the CPU 104 can detect a connection of the SSD-B. Alternatively, it is also possible to employ a configuration in which the CPU 104 detects the connection of the SSD-B which is to be added on to the connector 136, on the basis of communication with the SSD-B. In this case, in step S103, the CPU 104 causes the storage controller 115 to execute communication with the SSD-B, and detects a connection of the SSD-B in accordance with the existence or absence of a response from the SSD-B. If there is a response from the SSD-B, the CPU 104 determines that the SSD-B has been added on.

Upon completion of adding on of the SSD-B, in step S104, the CPU 104 starts a copy operation for copying (backing up) data stored in the SSD-A to the SSD-B. In such a case, the CPU 104 instructs the storage controller 115 so as to perform a mirroring (RAID 1) operation between the SSD-A and the SSD-B. By this, the storage controller 115 writes data to both of the SSD-A and the SSD-B when write access occurs with respect to a storage. Note that the CPU 104 may display on the operation unit 124 a message indicating that copying (backing up) of data is underway during execution of the copy operation.

Next, in step S105, the CPU 104 determines whether or not the copying of data from the SSD-A to the SSD-B has completed. The CPU 104 determines that copying of data has completed upon receiving a notification from the storage controller 115 indicating that copying of data has completed. The CPU 104 repeats the determination of step S105 if copying of data has not completed, and advances the processing to step S106 if the copying completes.

In step S106, the CPU 104 changes the storage to use from the SSD-A to the SSD-B by instructing the storage controller 115 to switch from usage of the SSD-A to usage of the SSD-B. Subsequently, in step S107, the CPU 104 causes the storage controller 115 to stop the SSD-A, and advances the processing to step S108. Note that the stoppage of the SSD-A may be stoppage of access to the SSD-A, or may be stoppage of a supply of power from the power supply unit 102. Access to the SSD-A can be stopped by disconnecting a communication link between the storage controller 115 and the SSD-A, or by causing a function in the storage controller 115 for communicating with the SSD-A to transition to a reset state.

In the present embodiment, supply of power (power supply) from the power supply unit 102 to the SSD-A and the SSD-B is controlled by the power supply controller 103. The power supply controller 103 controls supply of power to the SSD-A and the SSD-B in accordance with an instruction from the CPU 104. Specifically, upon determining that the end of the lifetime of the SSD-A is near (step S101) and detecting the connection of the SSD-B to the connector 136 (step S103), the CPU 104 causes supply of power from the power supply unit 102 to the SSD-B to start. By this, it is possible to prevent power from being unnecessarily supplied to the SSD-B if the SSD-B is added on before the end of the lifetime of the SSD-A is near.

In addition, upon detecting the connection of the SSD-B to the connector 136 (step S103) and determining that copying of data from the SSD-A to the SSD-B has completed (step S105), the CPU 104 causes supply of power from the power supply unit 102 to the SSD-A to stop. By this, it is possible to realize power saving by stopping supply of power to the SSD-A while the SSD-B is in use, while reliably copying the data stored in the SSD-A to the SSD-B. Note that the power supply controller 103 may make a decision on starting and stopping of the supply of power to the SSD-A and the SSD-B on its own and independent of an instruction from the CPU 104.

In step S108, the CPU 104 determines whether or not to have the power supply 101 enter the off state based on whether a power supply off instruction has been received from a user. If a power supply off instruction is received, the CPU 104 determines to have the power supply 101 enter the off state, ends this processing, and performs shutdown processing. Meanwhile, if a power supply off instruction has not been received, the CPU 104 returns the processing to step S101.

As explained above, in the present embodiment, the CPU 104 prompts a user to add on the SSD-B in a case where the end of the lifetime of the SSD-A which is in use is near (in a case where the total data amount D1 exceeds the threshold value Dth1). Furthermore, the CPU 104 copies (backs up) data stored in the SSD-A to the added on SSD-B, and changes the SSD to use from the SSD-A to the SSD-B. By this, it is possible to add on a storage while continuing operation of the MFP 150 when the end of the lifetime of a storage in use is near. In addition, it is possible to reduce power consumption of the MFP 150 by causing the SSD-A to stop after changing the storage to use to the SSD-B.

### Second Embodiment

In the first embodiment, if the end of the lifetime of the SSD-A installed in the MFP 150 is near, operation of the MFP 150 is allowed to continue by switching the storage (SSD) to use to the SSD-B which was added on. In the second embodiment, when the end of the lifetime of the SSD-B which was added on is near during usage of the SSD-B, it is further possible to exchange the SSD-B while enabling operation of the MFP 150 to continue. Explanation regarding portions in common with the first embodiment is omitted below.

<Setting of Threshold Values Dth1 and Dth2>

In the present embodiment, when the end of the lifetime of the SSD-A is near, the storage to use is switched from the SSD-A to the SSD-B, similarly to in the first embodiment. Subsequently, when the end of the lifetime of the SSD-B is near, a backup of data stored in the SSD-B is performed to make it possible to exchange the SSD-B. Specifically, the SSD-A is activated, and an onboard backup for temporarily backing up the data stored in the SSD-B to the SSD-A is performed. Subsequently, when the SSD-B is exchanged for a new SSD, the data backed up to the SSD-A is copied to the new SSD, and the SSD-A is stopped again. By such processing, it is possible to continue operation of the MFP 150 without exchanging the substrate 200 (in other words, exchanging the controller 100) on which the SSD-A is mounted.

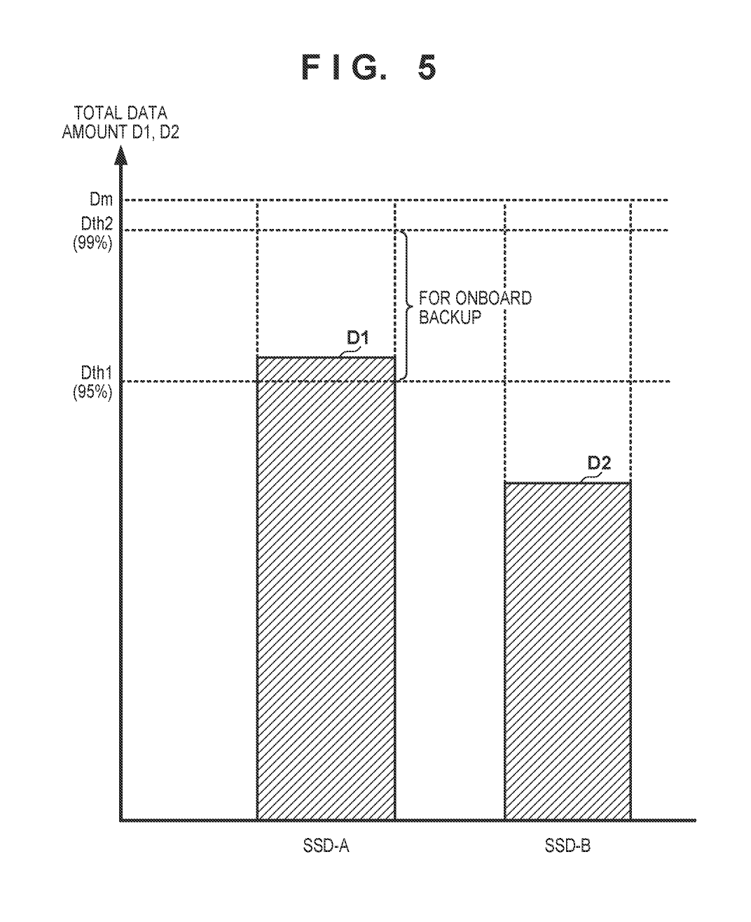

Here, FIG. 5 illustrates an example of setting threshold values Dth1 and Dth2 used in determinations regarding the lifetime of the SSD-B and the SSD-A which are installed in the MFP 150. In the present embodiment, the CPU 104 determines that the end of the lifetime of the SSD-A is near when the total data amount D1 written to the SSD-A exceeds the threshold value Dth1, similarly to in the first embodiment. In addition, the CPU 104 determines that the end of the lifetime of the SSD-B is near when the total data amount D2 written to the SSD-B exceeds the threshold value Dth2. As illustrated in FIG. 5, the threshold values Dth1 and Dth2 are set to different values.

The threshold value Dth2 for the SSD-B can be set to any value, and for example it is set to a value as close as possible to the total data amount (in other words, the total data amount that can be written) Dm corresponding to the lifetime of the SSD-B (for example it is set closer to Dm than the threshold value Dth1). In FIG. 5, as an example, the threshold value Dth2 is set to a value that is 99% of the total data amount (in other words, the total writeable data amount) Dm corresponding to the lifetime of the SSD-B (Dth2=0.99*Dm).

In contrast, the threshold value Dth1 for the SSD-A is set so that the onboard backup to the SSD-A described above is possible when the end of the lifetime of the SSD-B is near. In a case where Dth1 is set to a value close to Dm, the storage capacity of the SSD-A for temporarily backing up data from the SSD-B to the SSD-A lacks, and the backup cannot be performed when the end of the lifetime of the SSD-B is near. Therefore, the threshold value Dth1 is set so as to ensure a remaining amount of data that can be written to the SSD-A for the onboard backup. For example, the threshold value Dth1 is set to a value lower than the threshold value Dth2 for the SSD-B. In FIG. 5, it is set to a value that is 95% of the total data amount Dm corresponding to the lifetime of the SSD-A as an example (Dth1=0.95*Dm).

As illustrated in FIG. 5, it is possible to set the threshold values Dth1 and Dth2 as ratios with respect to a total data amount Dm corresponding to the lifetime of the SSD-A and the SSD-B. Note that FIG. 5 illustrates an example in which the total data amount Dm corresponding to the lifetime of the SSD-A and the SSD-B is the same for the SSD-A and the SSD-B, but the total data amount Dm may be different for the SSD-A and the SSD-B.

<Example of Operation States of Storage>

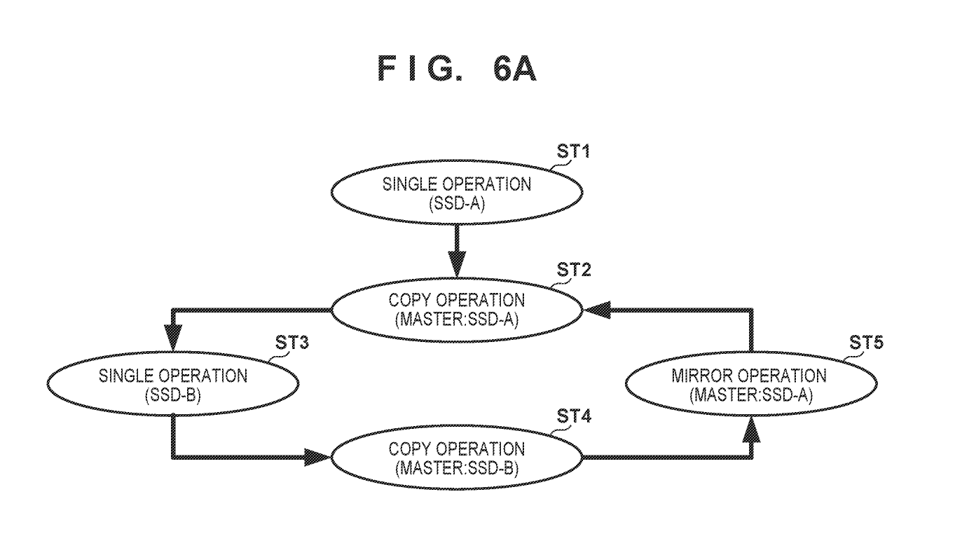

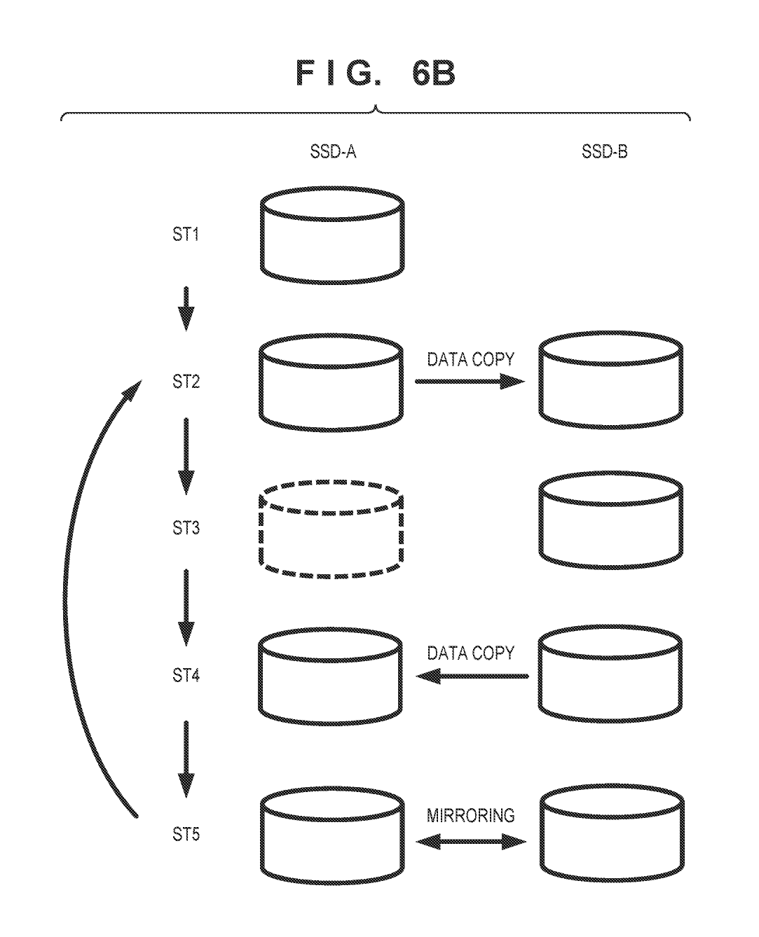

FIG. 6A is a state transition diagram that illustrates an example transitions of operation states of the MFP 150, and FIG. 6B illustrates an example of controlling the SSD-A and the SSD-B in each operation state. As operation states relating to the storages (the SSD-A and the SSD-B) installed in the MFP 150, the MFP 150 has five states: a state 1 (ST1), a state 2 (ST2), a state 3 (ST3), a state 4 (ST4), and a state 5 (ST5).

If the SSD-B has not been added on to the MFP 150, the MFP 150 performs an operation (single operation) in a single mode where only the SSD-A that is the onboard SSD is used (ST1). Subsequently, if the total data amount D1 written to the SSD-A exceeds the threshold value Dth1, a notification prompting the adding on of the SSD-B is made to a user, and the adding on of the SSD-B is awaited.

When the SSD-B is added on, the MFP 150 transitions from ST1 to ST2. In ST2, the MFP 150 copies data from the SSD-A to the SSD-B, while performing a mirroring operation between the SSD-A and the SSD-B with the SSD-A set as a master. Upon completion of the copying of data to the SSD-B, the MFP 150 transitions from ST2 to ST3. In ST3, the MFP 150 stops the SSD-A to thereby perform operation (single operation) in a single mode where only the SSD-B is used.

Subsequently, if the total data amount D2 written to the SSD-B exceeds the threshold value Dth2, the MFP 150 transitions from ST3 to ST4. In ST4, the MFP 150 activates the SSD-A, and copies data from the SSD-B to the SSD-A, while performing a mirroring operation between the SSD-A and the SSD-B with the SSD-B set as a master. Upon completion of the copying of data to the SSD-A, the MFP 150 transitions from ST4 to ST5. In ST5, the MFP 150 continues the mirroring operation between the SSD-A and the SSD-B. Note that, while the mirroring operation is continuing, the MFP 150 makes a notification for prompting a user to exchange the SSD-B, and waits for the SSD-B to be exchanged.

If the SSD-B has been exchanged, the MFP 150 returns from ST5 to ST2. In this way, the MFP 150 repeats the operation in ST2 through ST5.

<Procedure for Switching Storage>

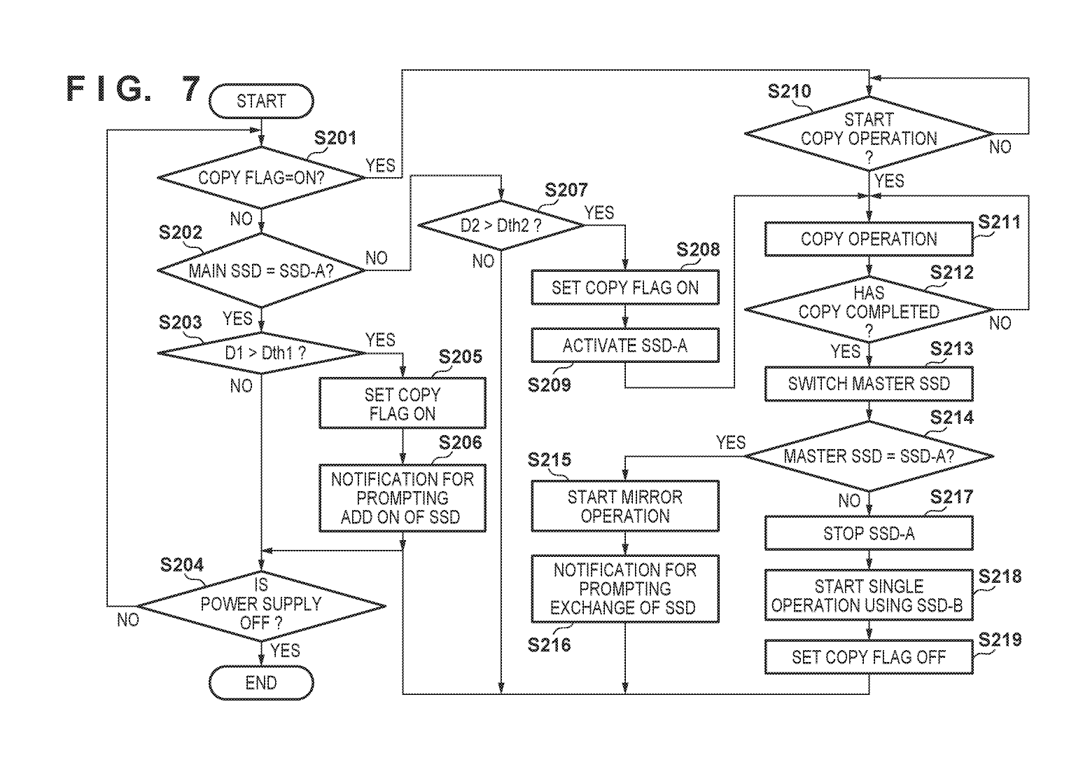

FIG. 7 is a flowchart illustrating a procedure for switching the storage to use in the MFP 150, according to the second embodiment. The processing of each step illustrated in FIG. 7 is realized in the MFP 150 by processing in which the CPU 104 reads out a control program stored in the ROM 105 or the like and executes the control program. Note that the processing of each step may be realized by hardware such as an FPGA or an ASIC. Explanation is given below centered on points of difference with the first embodiment (FIG. 4).

When the power supply 101 of the MFP 150 is activated from an off state to an on state, the CPU 104 starts execution of processing in accordance with the procedure of FIG. 7. Note that processing according to the procedure of FIG. 7 can be executed in parallel with a normal operation by the MFP 150 (an operation such as copying, scanning, and printing) while the power supply 101 is in the on state. The threshold value Dth1 for the SSD-A and Dth2 for the SSD-B are each predetermined as described above, and are held by the setting holder 133.

In step S201, the CPU 104 determines whether or not a copy flag has been set to on (ON). The copy flag is a flag for indicating a setting of whether or not it is necessary to perform, between the SSD-A and the SSD-B, a copy of data from one SSD (a main SSD) to the other SSD, and the copy flag is held by the setting holder 133. If the copy flag has been set to off (OFF), the CPU 104 advances the processing to step S202, and if the copy flag has been set to on, the CPU 104 advances the processing to step S210. Note that, in an initial state of the MFP 150 (the operation state of ST1 in FIG. 6A and FIG. 6B), the copy flag has been set to off in advance.

In step S202, the CPU 104 determines whether or not the SSD-A is the main SSD. In the present embodiment, the main SSD corresponds to an SSD that is used for operation in the single mode, or an SSD that has been set to the master in the mirroring operation. If the SSD-A is the main SSD, the CPU 104 advances the processing to step S203, and if the SSD-A is not the main SSD (the SSD-B is the main SSD), the CPU 104 advances the processing to step S207.

In step S203, the CPU 104 determines whether or not the total data amount D1 written to the SSD-A which is the SSD in use exceeds a predetermined threshold value Dth1 (for example, 95% of Dm) (whether or not D1>Dth1 is satisfied), and if the threshold value Dth1 is not exceeded, advances the processing to step S204. In a case of having advanced the processing to step S204, the CPU 104 determines whether or not to have the power supply 101 enter the off state based on whether or not a power supply off instruction has been received from a user. If a power supply off instruction is received, the CPU 104 determines to have the power supply 101 enter the off state, ends this processing, and performs shutdown processing. Meanwhile, if a power supply off instruction has not been received, the CPU 104 returns the processing to step S201. The MFP 150 at this point is in the operation state of ST1 illustrated in FIG. 6A and FIG. 6B. In this way, the CPU 104 repeats the processing of step S204 and step S201 through step S203 as long as the total data amount D1 does not exceed the threshold value Dth1, in the operation state of ST1.

If the total data amount D1 exceeds the threshold value Dth1 in step S203, the CPU 104 advances the processing to step S205, and sets the copy flag to on. Furthermore, in step S206, the CPU 104 makes a notification prompting a user to add on an SSD (the SSD-B), and advances the processing to step S204. Subsequently, the CPU 104 returns the processing from step S204 to step S201 if a power supply off instruction has not been received. As a result, by the copy flag having been set to on, the CPU 104 advances the processing from step S201 to step S210.

In step S210, the CPU 104 determines whether or not to perform a copy operation, between the SSD-A and the SSD-B, for data stored in the main SSD. The determination in step S210 is performed based on the operation state of the MFP 150 (the storage controller 115), and SMART information obtained from the SSD-A and the SSD-B. In a case of having determined to perform a copy operation, the CPU 104 advances the processing from step S210 to step S211.

Specifically, the CPU 104 determines, based on the SMART information, whether or not the SSD-B has been added on if the operation state of the MFP 150 is ST1. Upon determining that the SSD-B has been added on, the CPU 104 causes the operation state of the MFP 150 to transition from ST1 to ST2, and advances the processing to step S211. In addition, the CPU 104 determines, based on the SMART information, whether or not the SSD-B has been exchanged for a new SSD if the operation state of the MFP 150 is ST5. Upon determining that the SSD-B has been exchanged, the CPU 104 causes the operation state of the MFP 150 to transition from ST5 to ST2, and advances the processing to step S211.

In step S211, the CPU 104 performs a copy operation for the data stored in the main SSD. Here, if the operation state of the MFP 150 is ST2, data is copied from the SSD-A to the SSD-B. Subsequently, in step S212, the CPU 104 determines whether or not the copy of data has completed, and advances the processing to step S213 when the copy completes.

In step S213, the CPU 104 instructs the storage controller 115 to change the SSD used as the master (the master SSD). If the operation state of the MFP 150 is ST2, the CPU 104 changes the master SSD from the SSD-A to the SSD-B, and advances the processing to step S214.

In step S214, the CPU 104 determines whether or not the SSD-A is the master SSD, advances the processing to step S215 if the SSD-A is the master SSD, and advances the processing to step S217 if the SSD-B is the master SSD. Here, the CPU 104 advances the processing to step S217 if the operation state of the MFP 150 is ST2, and advances the processing to step S215 if the operation state of the MFP 150 is ST4.

In step S217, the CPU 104 causes the SSD-A to stop by making an instruction to the power supply controller 103 so as to stop supply of power to the SSD-A from the power supply unit 102. If the SSD-A stops, next, in step S218, the CPU 104 starts single operation in which only the SSD-B is used, and advances the processing to step S219. In step S219, the CPU 104 sets the copy flag to off, and advances the processing to step S204. At this point, the CPU 104 causes the operation state of the MFP 150 to transition from ST2 to ST3.

Subsequently, if the operation state of the MFP 150 is ST3, the SSD-B is the main SSD (the master SSD). In this case, as long as a power supply off instruction has not been received, the CPU 104 returns the processing from step S204 to step S201, and further advances the processing from step S201 and step S202 to step S207.

In step S207, the CPU 104 determines whether or not the total data amount D2 written to the SSD-B which is the SSD in use exceeds the predetermined threshold value Dth2 (for example, 99% of Dm) (whether or not D2>Dth2 is satisfied), and if the threshold value Dth2 is not exceeded, advances the processing to step S204. In this case, the CPU 104 repeats the processing of step S204, step S201, step S202, and step S207. Meanwhile, when the total data amount D2 exceeds the threshold value Dth2 in step S207, the CPU 104 advances the processing to step S208, and sets the copy flag to on. Furthermore, in step S209, the CPU 104 causes the SSD-A to activate by making an instruction to the power supply controller 103 so as to start supply of power to the SSD-A from the power supply unit 102, and advances the processing to step S211. At this point, the CPU 104 causes the operation state of the MFP 150 to transition from ST3 to ST4.

If the operation state of the MFP 150 is ST4, in step S211 the CPU 104 copies data from the SSD-B (the main SSD) to the SSD-A. Subsequently, in step S212, the CPU 104 determines whether or not the copy of data has completed, and advances the processing to step S213 if the copy completes. In step S213, the CPU 104 changes the master SSD from the SSD-B to the SSD-A, and advances the processing to step S214. If the master SSD is the SSD-A, the CPU 104 advances the processing from step S214 to step S215. At this point, the CPU 104 causes the operation state of the MFP 150 to transition from ST4 to ST5.

In step S215, the CPU 104 starts the mirroring operation between the SSD-A and the SSD-B. Furthermore, in step S216, the CPU 104 makes a notification prompting a user to exchange the SSD-B, and advances the processing to step S204. Subsequently as a result of the processing of step S204 and step S201, the CPU 104 advances the processing to step S210, and determines whether or not the SSD-B has been exchanged with a new SSD. If it is determined that the SSD-B has been exchanged, the CPU 104 causes the operation state of the MFP 150 to transition from ST5 to ST2, advances the processing to step S211, and executes the processing of step S211 and onward as described above.

As explained above, in the present embodiment, if the total data amount D1 written to the SSD-A exceeds the threshold value Dth1, the CPU 104 changes the storage to use from the SSD-A to the SSD-B which has been connected to the connector 136. Subsequently, if the total data amount D2 written to the SSD-B exceeds the threshold value Dth2, the CPU 104 copies data stored in the SSD-B to the SSD-A in order to exchange the SSD-B. The threshold value Dth1 related to the lifetime of the SSD-A is set to a value lower than the threshold value Dth2 so that the end of the lifetime of the SSD-A is not reached by copying data in a period before the exchange of the SSD-B completes.

By virtue of the present embodiment, when the end of the lifetime of the SSD-B which was added on and is in use is near, it is possible to exchange the SSD-B while continuing operation of the MFP 150. In addition, when the end of the lifetime of the added-on SSD-B is near, it is possible to automatically copy data to the SSD-A mounted on the substrate 200 without requiring exchange of the substrate 200 itself.

Note that, in the embodiment described above, the total data amount D1 (D2) written to the SSD-A (the SSD-B) thus far is used as a parameter value relating to the lifetime of the SSD-A (the SSD-B) for determining whether or not the end of the lifetime of the SSD-A (the SSD-B) is near. However, a number of times data has been written to the SSD-A (the SSD-B) thus far may be used as the parameter value relating to the lifetime of the SSD-A (the SSD-B). In such a case, the threshold values Dth1 and Dth2 may be set as ratios with respect to a number of writes corresponding to the lifetime of the SSD-A (the SSD-B) (in other words, a number of times data can be written).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-007883, filed Jan. 19, 2017, which is hereby incorporated by reference herein in its entirety.

What is claimed is:

1. An information processing apparatus comprising:
a first storage device mounted on a substrate of the information processing apparatus;
a connector provided on the substrate to which a storage device for adding on is connected;
a change unit configured to change a storage device to use from the first storage device to a second storage device connected to the connector in a case where a total amount of data written to the first storage device exceeds a first threshold value; and
a copy unit configured to, in a case where a total amount of data written to the second storage device exceeds a second threshold value, copy data stored in the second storage device to the first storage device for an exchange of the second storage device,
wherein the first threshold value is set to a value lower than the second threshold value.

2. The information processing apparatus according to claim 1,
wherein the second threshold value is set to a value closer to a total amount of data corresponding to a lifetime of the first and second storage devices than the first threshold value.

3. The information processing apparatus according to claim 1,
wherein the first threshold value is set so that an end of a lifetime of the first storage device is not reached in accordance with copying of data by the copy unit until exchange of the second storage device completes.

4. The information processing apparatus according to claim 1,
wherein the first and second threshold values are respectively set as ratios with respect to total amounts of data corresponding to a lifetime of the first and second storage devices.

5. The information processing apparatus according to claim 1,
wherein the change unit causes the first storage device to stop after the storage device to use changes from the first storage device to the second storage device.

6. The information processing apparatus according to claim 5,
wherein the change unit causes the first storage device to stop by stopping access to the first storage device or by stopping a supply of power to the first storage device.

7. The information processing apparatus according to claim 5,
wherein the copy unit causes the first storage device to activate before starting a copy of data to the first storage device.

8. The information processing apparatus according to claim 1,
further comprising a mirroring unit configured to perform mirroring between the first storage device and the second storage device after copying of data by the copy unit to the first storage device completes.

9. The information processing apparatus according to claim 8,
wherein the mirroring unit set the first storage device as a master to perform mirroring.

10. The information processing apparatus according to claim 1,
wherein, after the exchange of the second storage device completes, the copy unit copies data stored in the first storage device to the exchanged second storage device.

11. The information processing apparatus according to claim 10,
wherein the copy unit causes the first storage device to stop after the copying of the data to the exchanged the second storage device completes.

12. The information processing apparatus according to claim 11,
wherein the copy unit causes the first storage device to stop by stopping access to the first storage device or by stopping a supply of power to the first storage device.

13. The information processing apparatus according to claim 1,
wherein the total amount of data written to the first storage device and the total amount of data written to the second storage device are respectively obtained from SMART information of the first and second storage device.

14. The information processing apparatus according to claim 1,
wherein the first and the second storage devices are SSDs.

15. The information processing apparatus according to claim 1,
further comprising a notification unit configured to make a notification for prompting a user to add on a storage device to be connected to the connector in the case where the total amount of data written to the first storage device exceeds the first threshold value.

16. The information processing apparatus according to claim 1,
further comprising a detection circuit configured to detect a connection of the second storage device to the connector,
wherein the change unit detects the connection of the second storage device to the connector by using the detection circuit.

17. The information processing apparatus according to claim 1,
wherein the change unit detects the connection of the second storage device to the connector in accordance with communication via the connector.

18. An information processing apparatus comprising:
a first storage device mounted on a substrate of the information processing apparatus;
a connector provided on the substrate to which a storage device for adding on is connected;
a change unit configured to change a storage device to use from the first storage device to a second storage device connected to the connector in a case where a number of times data is written to the first storage device exceeds a first threshold value; and
a copy unit configured to, in a case where a number of times data is written to the second storage device exceeds a second threshold value, copy data stored in the second storage device to the first storage device for an exchange of the second storage device,
wherein the first threshold value is set to a value lower than the second threshold value.

19. A method of controlling an information processing apparatus provided with a first storage device mounted on a substrate and a connector provided on the substrate to which a storage device for adding on is connected, the method comprising:
changing a storage device to use from the first storage device to a second storage device connected to the connector in a case where a total amount of data written to the first storage device exceeds a first threshold value; and
in a case where a total amount of data written to the second storage device exceeds a second threshold value, copying data stored in the second storage device to the first storage device for an exchange of the second storage device,
wherein the first threshold value is set to a value lower than the second threshold value.

20. A non-transitory computer-readable storage medium storing a computer program for causing a computer to execute a method of controlling an information processing apparatus provided with a first storage device mounted on a substrate and a connector provided on the substrate to which a storage device for adding on is connected, the method comprising:
changing a storage device to use from the first storage device to a second storage device connected to the connector in a case where a total amount of data written to the first storage device exceeds a first threshold value; and
in a case where a total amount of data written to the second storage device exceeds a second threshold value, copying data stored in the second storage device to the first storage device for an exchange of the second storage device,
wherein the first threshold value is set to a value lower than the second threshold value.
